(19) United States
(12) Patent Application Publication
(10) Pub. No.: US 2013/0073996 A1
(43) Pub. Date: Mar. 21, 2013

(54) Computer-Implemented Systems And Methods For Providing Tactical Information To A Crisis Responder

(71) Applicants: Gene Garcia, Highland, CA (US); Adam Hebden, Redlands, CA (US)

(72) Inventors: Gene Garcia, Highland, CA (US); Adam Hebden, Redlands, CA (US)

(21) Appl. No.: 13/622,592

(22) Filed: Sep. 19, 2012

Related U.S. Application Data
(60) Provisional application No. 61/536,878, filed on Sep. 20, 2011.

(51) Int. Cl. G06F 3/048

(52) U.S. Cl. 715/764

(57) ABSTRACT

Systems and methods are provided for providing tactical information to a crisis responder. A system includes a tactical information user interface that includes a site map display that provides a depiction of features at a site of interest, where semi-opaque polygons are overlaid over structures for which drill down data is available. One of the one or more structures is identified as the structure of interest upon selection of an associated semi-opaque polygon in the site map display. The interface includes a floor plan display. A floor plan includes one or more identified areas for which drill down data is available. The interface includes a panoramic photo display that provides a photo of an area of interest, where one of the one or more identified areas is identified as the area of interest upon selection of that area in the floor plan display.

### CROSS-REFERENCE TO RELATED APPLICATIONS

This application claims priority to U.S. Provisional Patent Application No. 61/536,878 filed on Sep. 20, 2011, entitled “Computer-Implemented Systems and Methods for Providing Tactical Information to a Crisis Responder,” the entirety of which is herein incorporated by reference.

### TECHNICAL FIELD

This document relates generally to computer-implemented data display and more particularly to providing tactical information to a crisis responder.

### BACKGROUND

Sadly, in recent times, we have become all too familiar with crisis situations such as the Columbine High School shooting incident which left several people dead and many more injured. During that incident, when emergency personnel such as Police, Fire and SWAT personnel responded to the situation, these trained men and women faced many uncertainties that significantly added to the potentially life-threatening risks that they faced—uncertainties which adversely impacted their effectiveness in quickly and safely resolving the situation with minimal risk to civilians and themselves.

For example, during the initial response to the Columbine High School incident when police personnel approached the school premises, they were unaware of the safest, or, more significantly, the most dangerous, route to approach the school buildings and parking lots. For example, they were not aware of which areas were most vulnerable to attack by sniper gun fire while approaching a particular building. They were further unaware of key school personnel to contact, nor did they have access to their contact information. Furthermore, emergency personnel were unaware of building construction and structural information that would have assisted them to strategically plan entry into various building locations. These unknowns, and many others, greatly increased the risk to those individuals responding to the crisis.

As a particular example, when emergency rescue personnel finally entered the buildings, fire alarm sprinklers had flooded the interior rooms, an alarm strobe light was flickering, and an audio alarm was loudly sounding. As a result of these intense stimuli, some of the rescue team members who had prolonged exposure to this environment, suffered from vertigo, which adversely affected their perception and balance. Needless to say, this situation detrimentally affected their effectiveness and posed an otherwise unnecessary risk to these individuals. However, because emergency personnel did not know how to shut off the alarm systems, these strategically undesirable conditions persisted, making an already intensely stressful situation even more difficult.

In light of the difficulties and problems described above, there is a need for a method and system that can effectively provide critical tactical information to emergency personnel during crisis situations. Because such situations inherently involve high levels of stress and panic, it is desirable that such methods and systems be extremely “user friendly” and allow personnel to quickly and easily obtain a variety of different types of information that may be pertinent to address a particular situation or tactical plan.

### SUMMARY

In accordance with the teachings herein, systems and methods are provided for providing tactical information to a crisis responder. A system includes a tactical information user interface that includes a site map display that provides a depiction of features at a site of interest, where semi-opaque polygons are overlaid over structures for which drill down data is available. One of the one or more structures is identified as the structure of interest upon selection of an associated semi-opaque polygon in the site map display. The interface includes a floor plan display. A floor plan includes one or more identified areas for which drill down data is available. The interface includes a panoramic photo display that provides a photo of an area of interest, where one of the one or more identified areas is identified as the area of interest upon selection of that area in the floor plan display. The interface further includes a real-time data display that provides real time data associated with the site of interest, where the real-time data display provides real-time picture, video, or sensor data in conjunction with one or more of the site map display, the floor plan display, and the panoramic photo display.

### BRIEF DESCRIPTION OF THE FIGURES

FIG. 1 is a block diagram depicting a computer-implemented tactical data display engine.

FIG. 2 is a block diagram depicting interactions among a tactical data display interface, a tactical data display engine, and a tactical data data store.

FIG. 3 depicts a graphical user interface that includes a site map display.

FIG. 4 depicts a graphical user interface that includes a floor plan display.

FIG. 5 depicts a graphical user interface depicting a panoramic photo display.

FIG. 6 depicts an enlarged version of the floor plan display of FIG. 5 to highlight the field of vision indicator.

FIG. 7 is a graphical user interface depicting an item data overlay on a panoramic photo.

FIG. 8 is a graphical user interface displaying a data portion of a panoramic photo display after selection of an expand all sections control.

FIG. 9 is a graphical user interface displaying an item photo upon selection of an item in the data display.

FIG. 10 is a graphical user interface depicting an accessing of information via menus.

FIG. 11 is a graphical user interface displaying key personnel data.

FIG. 12 is a graphical user interface depicting overlaying of real-time mobile entity data.

FIG. 13 is a graphical user interface displaying a menu for selecting maps and floor plans via a text list.

FIG. 14 is a graphical user interface that includes display markup tools.

FIG. 15 is a graphical user interface depicting a range ring generation.

FIG. 16 is a graphical user interface depicting a set of range lines.

FIG. 17 is a graphical user interface displaying a search tool accessed from a tools menu.

FIG. 18 is a graphical user interface depicting search results.

FIG. 19 is a graphical user interface depicting administrative options.

FIGS. 20A, 20B, and 20C depict example systems for use in implementing a tactical data display engine.

### DETAILED DESCRIPTION

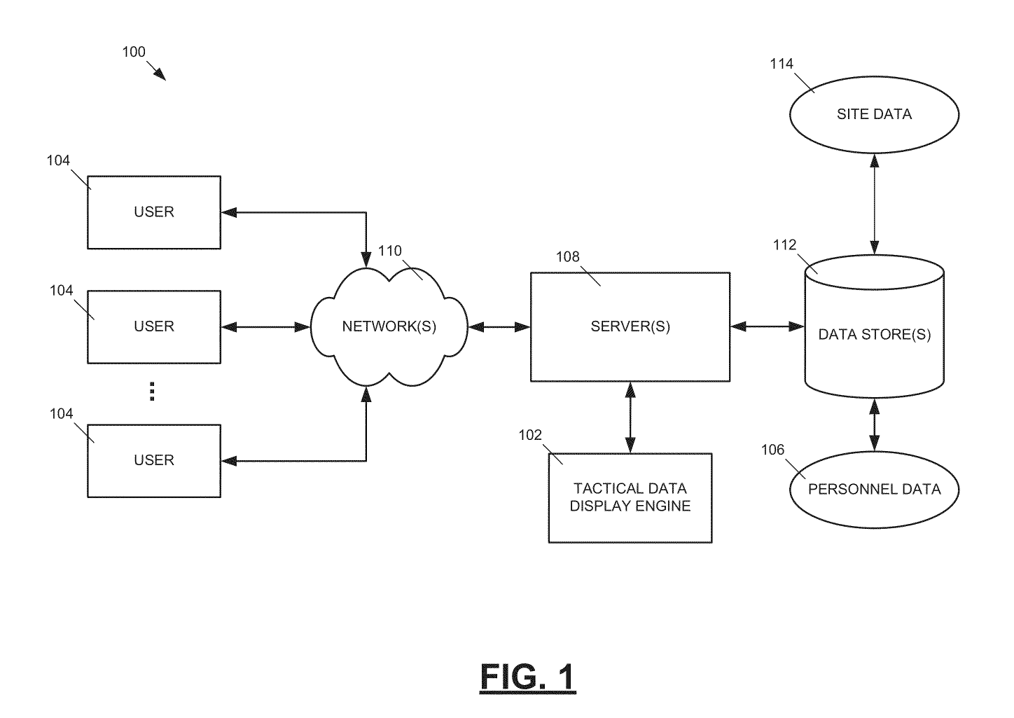

FIG. 1 is a block diagram depicting a computer-implemented tactical data display engine. The tactical data display engine 102 facilitates the transmission of tactical data to crisis responders. Such data can be vital when the crisis responder is operating at an unfamiliar location. By offering the crisis responder important data about a site, floor plans and photos of structures, locations of items and controls in the structures, site personnel data, and a variety of other drill down data, decision making for the first responder can be vastly accelerated and improved, benefits which may be critical in saving lives and preventing losses.

The tactical data may be provided in an offline mode, where the tactical data is provided to a crisis responder on a mobile device using data stored locally on the mobile device. Data may be periodically loaded and updated on the mobile device so that current data is available for the crisis responder to view. The tactical data may also be provided in an online mode, such as via a wireless LAN or cellular network connection. The online mode can provide a number of additional benefits including the incorporation of real-time data (e.g., vehicle or personnel locations, video feeds from stationary cameras, vehicle cameras, personnel cameras) into the graphical user interfaces that provide the tactical data to the first responder.

Online or offline modes may be toggled via a menu. In an online mode, the tactical data display engine 102 may use the Microsoft Bing maps world map base layer. In an offline mode, the tactical data display engine 102 may operate without Bing maps world map base layer. Instead the engine may use custom world map tile layers for the area directly surrounding and including the location of the survey. This feature allows a user to see a satellite map view even if the user does not have Internet access.

FIG. 1 depicts a tactical data display engine operating in an online mode. The tactical data display engine 102 provides a platform for users 104 to access tactical data associated with a current site of interest. A user 104 accesses the tactical data display engine 102, which is hosted on one or more servers 106, via one or more networks 108. One or more data stores 110 are accessible to the one or more servers 106. The one or more data stores 110 may contain a variety of data that includes site data 112 and personnel data 114.

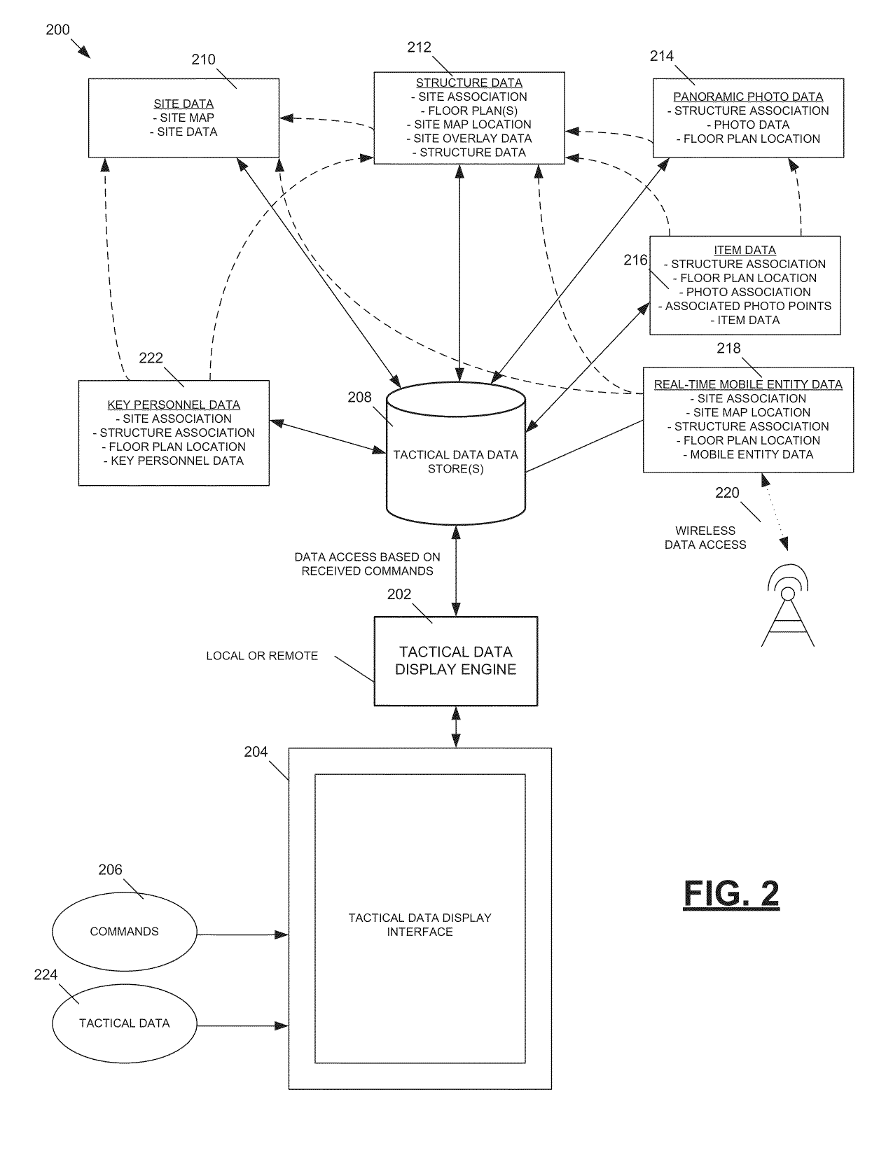

FIG. 2 is a block diagram depicting interactions among a tactical data display interface, a tactical data display engine and a tactical data data store. A user interacts with the tactical data display engine 202 via a tactical data display interface 204. The tactical data display interface may be provided to the user via a wireless device such as a web browser on a smart phone or other device (e.g., a personal computer). The tactical data display engine 202 may be retained locally on the mobile device or may be housed remotely and transmit data to the tactical data display interface 204.

By entering commands 206 to the tactical data display interface 204 a user can interact with the tactical data display engine 202 to access and display data. For example, a user may arrive at a site and be provided with a site map display in a first window. The site map display provides a depiction of features at the site of interest. The features may include one or more structures (e.g., buildings), where semi-opaque polygons are overlaid over structures on the map display for which drill down data is available (e.g., in the tactical data data store 208).

Upon selection of a structure of interest, a floor plan display may be provided for the structure of interest on the tactical data display interface 204 in a second window. The structure of interest may be selected by user interaction with an associated semi-opaque polygon in the site map display. The site map display may be zoomed and centered based on the structure of interest upon identification of the structure of interest, and the semi-opaque polygon associated with the structure of interest may be changed upon selection of the structure of interest (e.g., change of color, change of fill pattern).

The floor plan display may include a number of areas of interest for which drill down data is available. Upon selection of an area of interest, a panoramic photo display window may be displayed that provides a zoomable, rotatable photo of the selected area of interest.

When commands 206 are received and transmitted to the tactical data display engine 202, the tactical data display engine 202 may interact with the tactical data data store 208 to access the needed data to provide the requested display. The tactical data data store 208 may retain a variety of types of data. The data may be stored in a variety of fashions, including in a relational data base.

The data may include site data stored in a site data structure 210. The site data may include a site map and data related to the site such as the site location (e.g., latitude, longitude, directions to the site) as well as general notes about the site. The site map and site data may be initially provided to the user via the tactical data display interface 204, where data stored in the other data structures of the tactical data data store 208 may be accessed via commands 206 provided to the interface 204.

A structure data structure 212 may include data regarding structures (e.g., buildings) present in the site. Data for a structure may identify the site with which the structure is associated via a reference to a site data structure 210 record. The structure data may further include one or more floor plans for the structure that can be displayed upon selection of the structure, such as via a site map. The structure data may include data for displaying the location of the structure on the site map including a location of the structure on the site map as well as a shape and size for a semi-opaque polygon overlay for identifying the structure on the site map. The structure data may further include data regarding the structure itself, such as the number of floors, the age of the structure, and a size of the structure.

A panoramic photo data structure 214 may contain data for identifying areas of interest within a structure and for displaying a zoomable, rotatable photo of an area of interest. The panoramic photo data may include a structure association in the form of a reference to a structure data structure record. The panoramic photo data may include a floor plan location associated with the area of interest. The area of interest may be highlighted via an icon or other indicator to inform a user that a panoramic photo is available for the identified area on the floor plan. The panoramic photo data may also include the panoramic photo that is displayed to the user, such as via selection of the area of interest on the floor plan.

An item data structure 216 may contain data associated with items within a structure. The item data structure may include item data such as the name of the item, a description of the item, directions for using the item (e.g., an intercom, a utility control), as well as other data about the item. An item data structure may include a reference to a structure data structure 212 record and a floor plan location for identifying the item on the floor plan. The item data may also include a reference to a panoramic photo data record. The item data may include a location in a panoramic photo that depicts the item. The item data may be displayed upon selection of the item in a floor plan or selection of the location in the panoramic photo associated with the item. Additionally, item data for one or more items may be displayed on a panoramic photo near the location associated with the item (e.g., next to), such that item data for different items is displayed as the panoramic photo is zoomed and rotated.

The tactical data data store 208 may also receive real-time mobile entity data 218, such as via a wireless data connection 220. Mobile entity data may identify the location of mobile entities such as vehicles (e.g., cars, ships) as well as personnel (e.g., policemen, firemen, SWAT team members). The mobile entity data may include a link to a site data structure 210 record along with a location on a site map where a mobile entity should be overlayed. The mobile entity data may include a link to a structure data structure 210 record along with a location on a floor plan where a mobile entity should be overlayed. The mobile entity data may also include data about the mobile entity such as a name, call sign, photo, type, and status.

The real-time mobile entity data 218 may be useful in a variety of contexts. For example, real-time data may be provided to first responders to a building fire. In a building fire, smoke, fire, and fumes may impair visual abilities of fire fighters who have entered the building. Additionally, due to the nature of fires (e.g., threats of back drafts or fire spreading from breaking containment), it may be strategically sub-optimal to open certain doors or windows without knowledge of the current situation on the other side of those structures. Incorporation of real-time data, such as through live pictures or video, with structure data through the floor plan displays and panoramic photos of areas within the structure, a first responder can be offered a more comprehensive view of the current situation, enabling better decision making

For example, a real-time data display may provide a live video feed or sensor data from a room in a building. When a fire fighter reaches a door to that room, a floor plan display identifies what is generally in that room and where that room leads. A real-time data display may be displayed next to the floor plan, where the real-time data display shows a live video of the state of the room. If the real-time data display shows smoke in the room, and the floor plan indicates dangerous chemicals in the room, then the fire fighter may strategically decide not to open the door. Additionally, should the fire fighter choose to open the door and encounter the smoke filled room, the fire fighter can review the floor plan in conjunction with panoramic photos of the room prior to entry to identify the layout and items in the room. Such advance knowledge can enable higher quality on-the-fly decision making in the dangerous environment.

A key personnel data structure 222 may store data identifying key personnel associated with a site. The key personnel may be people that a user may expect to encounter or people that the user may need to contact for assistance. The key personnel data may include links to a site data structure 210 record, a structure data structure 212 record, and a floor plan location where a key personnel person can be expected to be encountered. Key personnel data may provide information about a key person including a name, position, photo, contact information, and notes about the person.

A user may also use the tactical data display interface 204 to enter tactical data 224 which may be used to update the tactical data data store 208. Such tactical data may include a current location of the user, recent photos of a location and the associated location for display to other users, status of the user, and live or recorded video.

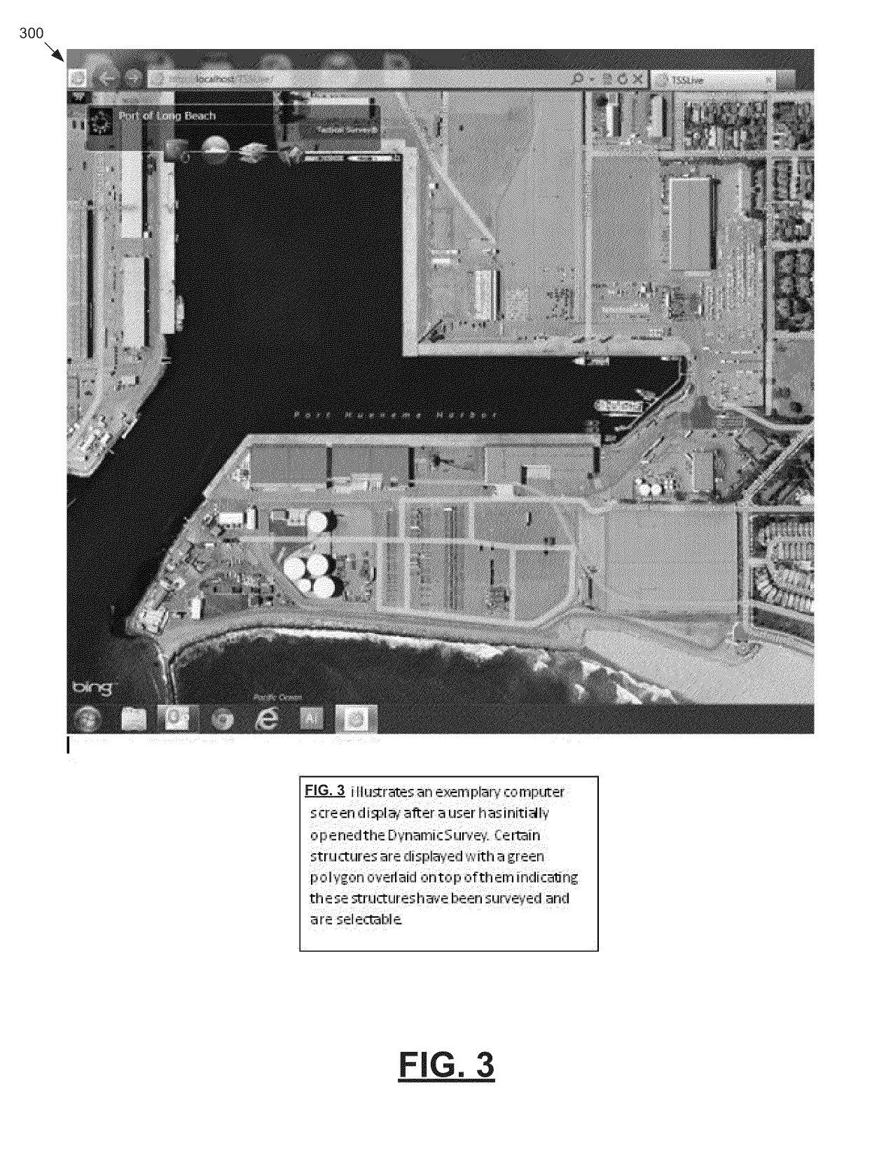

FIG. 3 depicts a graphical user interface that includes a site map display. Such a site map display may be provided upon initial access by the user to the tactical data display engine (“DynamicSurvey”). The site map display provides colored, semi-opaque polygons as overlays over buildings on the world map. When clicked, the semi-opaque polygons select a structure of interest. For single floor structures, a floor plan display is opened for the structure of interest. For multi-floor structures, a map of a first floor may be provided or a floor selector may be provided for selection of a desired floor plan map.

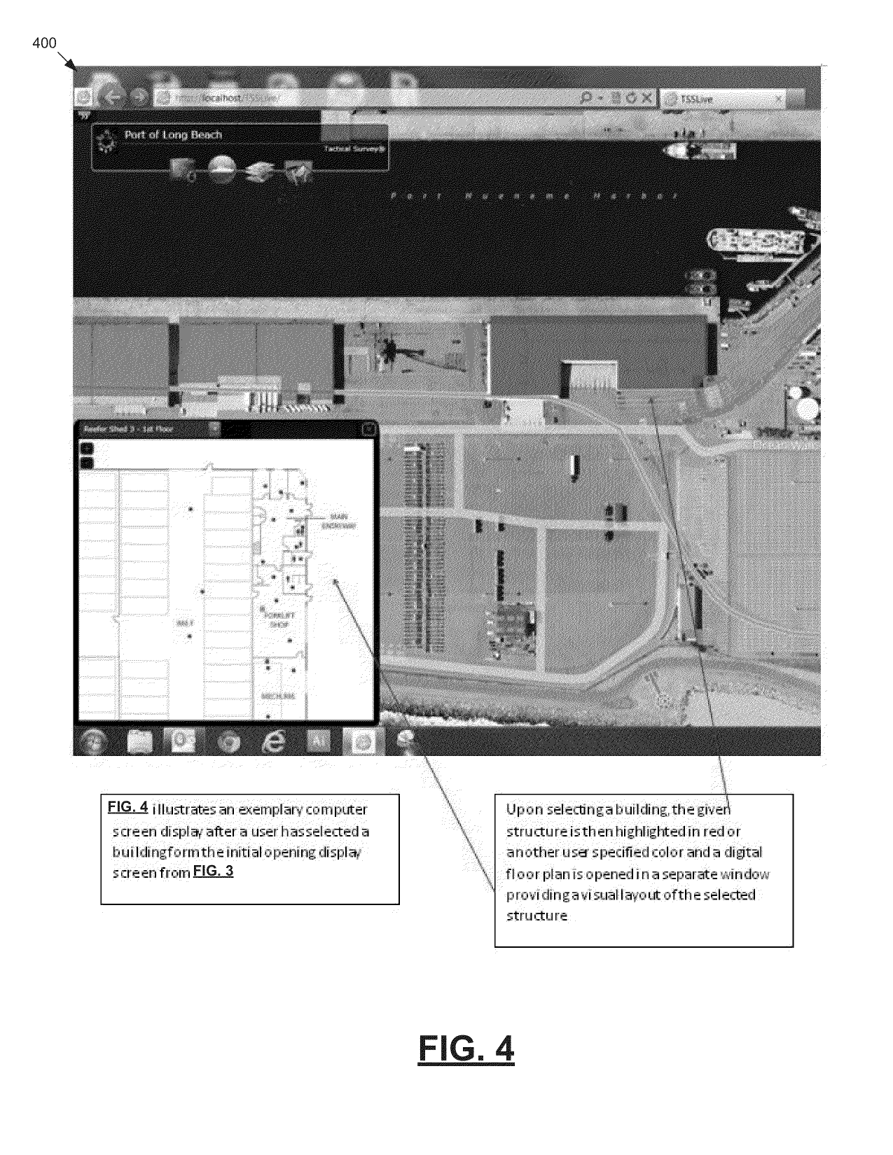

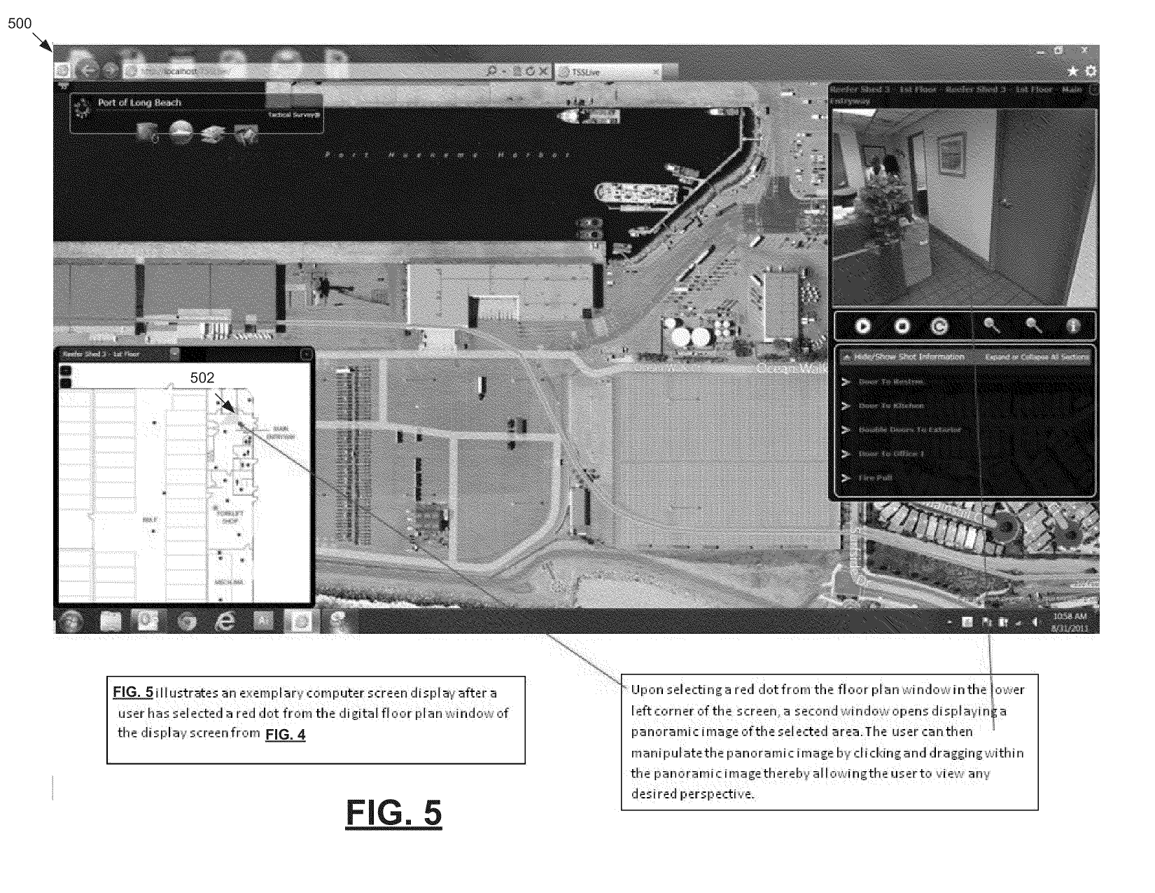

FIG. 4 depicts a graphical user interface that includes a floor plan display. The floor plan display may be provided after a user has selected a structure depicted on the site map. Upon selecting a structure, the site map may be zoomed and centered based on the selected structure, and a feature of the semi-opaque polygon associated with the selected structure of interest may be altered to identify which structure is selected and being displayed in the floor plan display. The floor plan display includes a pannable, zoomable floor plan. The floor plan display may be shown in a separate window from the site map. Such a feature may increase situational awareness ability of the user and allow for zooming and panning of the site map without affecting the floor plan map. The floor plan map may provide a list of floor plans for the structure of interest or all structures of the site.

The floor plan display includes a number of indicators of areas of interest. These indicators may be associated with a panoramic photo record or an item record. Upon selection of a panoramic photo record area, a panoramic photo display may be presented. Upon selection of an item record area, data associated with the item, which may include one or more photographs, is displayed.

FIG. 5 depicts a graphical user interface depicting a panoramic photo display. The panoramic photo display may be accessed by selecting a panoramic photo area of interest in the floor plan display of FIG. 4. The panoramic photo display may provide a 360 degree view of the area of interest, which may be created by stitching together several individual photographs. The panoramic photo display enables viewing, zooming, and rotating of the panoramic image. Move arrows may provide a virtual walk-through of a floor plan through providing of successive panoramic images associated with a floor plan. The panoramic photo display may include a number of controls such as a play button that will start a continuous rotation of the panoramic image, a stop button to stop the continuous rotation of the panoramic image, a button to enable continuous rotation every time a panoramic image is opened, a zoom in button to zoom closer in the panoramic image, a zoom out button to zoom back out in the panoramic image, a “display shot information” button to turn on the data boxes and move arrows in the panoramic image, a toggle button to hide or show the bottom data section and free up screen area, and an “expand or collapse all sections” toggle button to expand every item listed in the bottom data section.

The panoramic photo display may include a data section, as shown below the panoramic photo in FIG. 5. The data section may include identification of items depicted in the panoramic photo, where selection of an item enables a drilling down operation to access additional data and photos for the listed item.

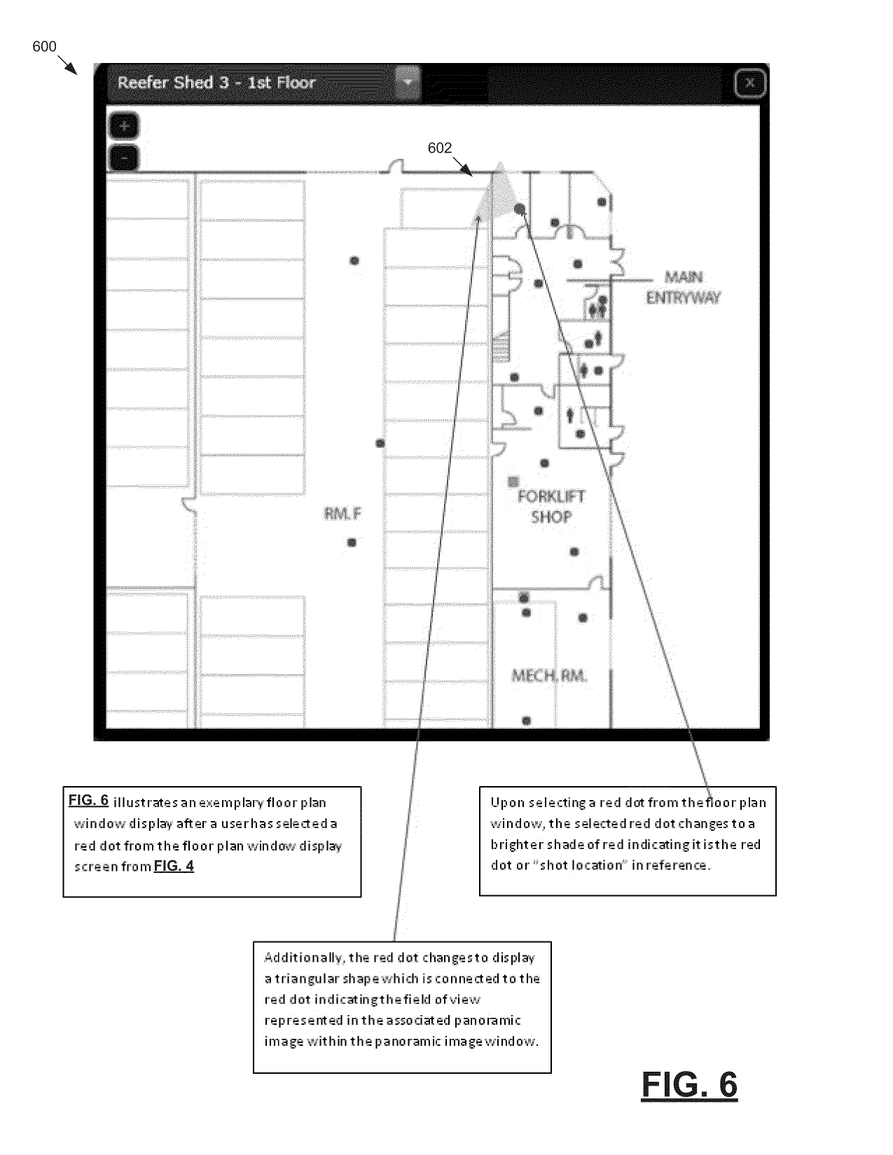

To help maintain a sense of direction when viewing a panoramic photograph, an indicator 502 may be provided on the floor plan display depicting a direction or field of vision of the presently displayed panoramic photo. FIG. 6 depicts an enlarged version of the floor plan display of FIG. 5 to highlight the field of vision indicator 602. Upon selecting an area of interest indicator, the indicator may change appearance (e.g., color change, size change) to indicate selection. A triangular shape is displayed to identify the field of view represented in the associated panoramic image within the panoramic photo display.

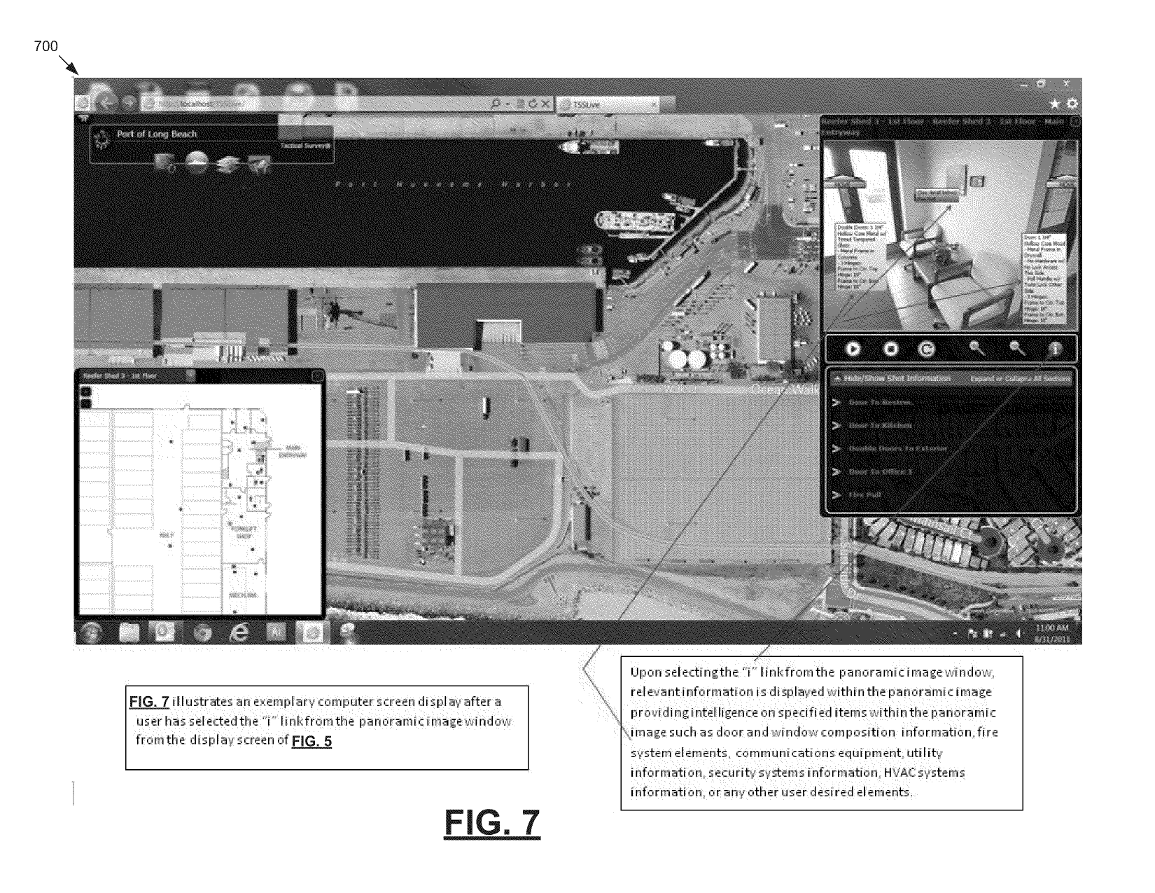

FIG. 7 is a graphical user interface depicting an item data overlay on a panoramic photo. The panoramic photo display may include a more information control, labeled “i”. Upon selection of the more information indicator, relevant information for items is overlayed next to or near the depiction of the item in the panoramic photo. Item data may include door and window composition information, fire system elements, communications equipment, utility information, security systems information, or HVAC systems information. In addition to providing item data via an overlay, item information may be provided in the item data box, where the item data is opened in response to clicking a location in the panoramic photo associated with the item. Item data may be stored in a hierarchical nature, where a first level for a door may include a location and type of door, and where lower levels may include additional properties such as a door composition, locking mechanism, and hinge placement, and photos of the object at different levels of detail.

Displayed data in the panoramic photo display and/or all other data displays may include data that can be copied for immediate portability to other applications. Drill down data may be provided in movable windows so that an entire hierarchy does not need to be displayed to access low level data.

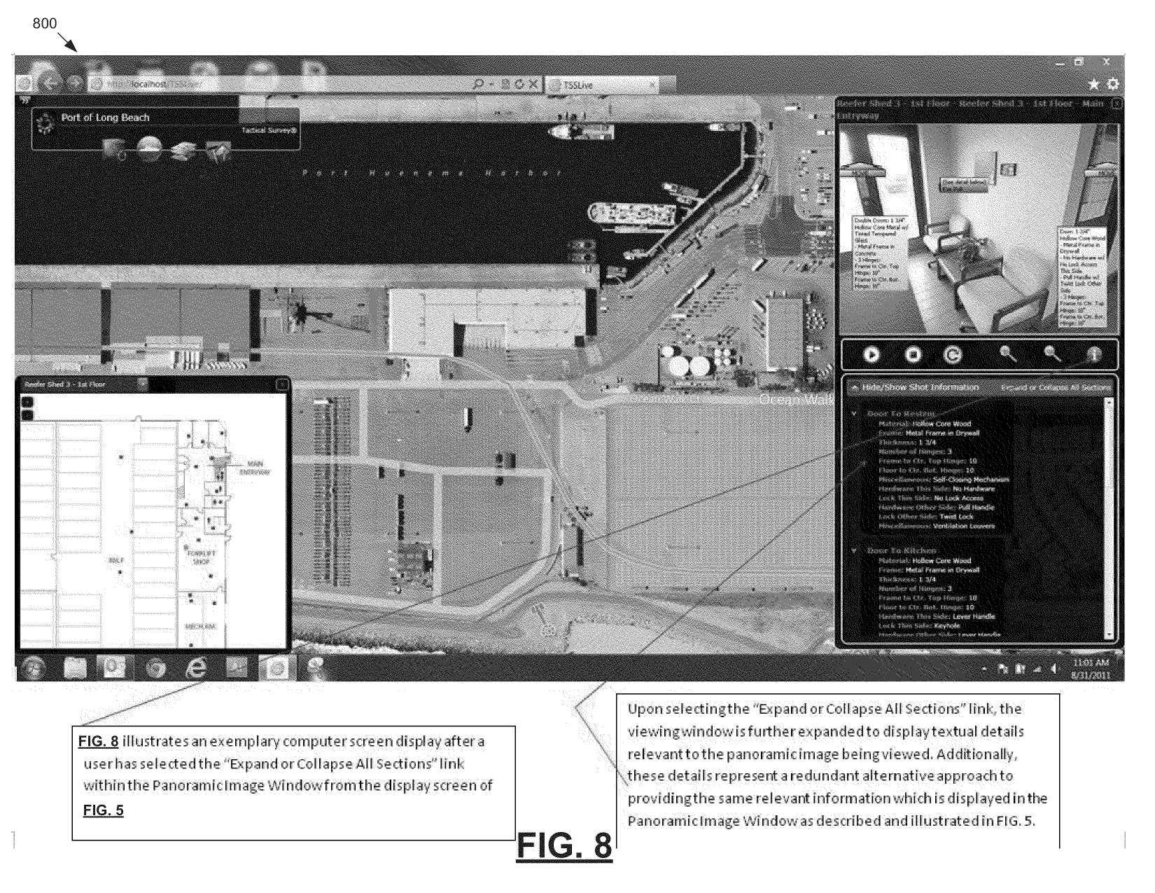

FIG. 8 is a graphical user interface displaying a data portion of a panoramic photo display after selection of an expand all sections control. Upon selection of the expand all sections control, the data section is expended to display all textual details relevant to all items in the panoramic image being viewed. Upon selection of an item in the data display, the panoramic image may be rotated and zoomed to display the selected item. Selection of a collapse all sections control collapses the data display so that only a top data layer is displayed.

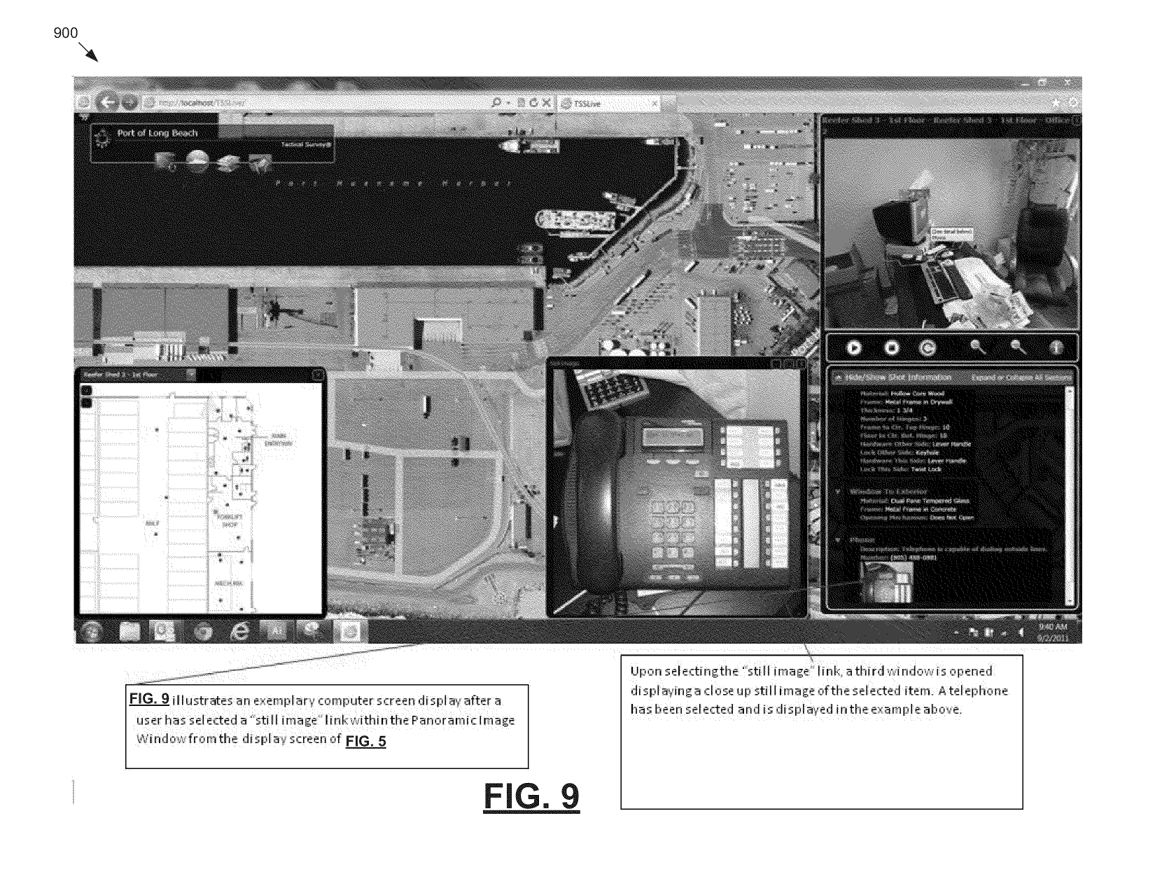

FIG. 9 is a graphical user interface displaying an item photo upon selection of an item in the data display. The data display section of the panoramic photo display may include a thumbnail photo of the item. Upon selection of the item or the item thumbnail, an enhanced photo may be shown in a different window that shows a close up image of the selected item.

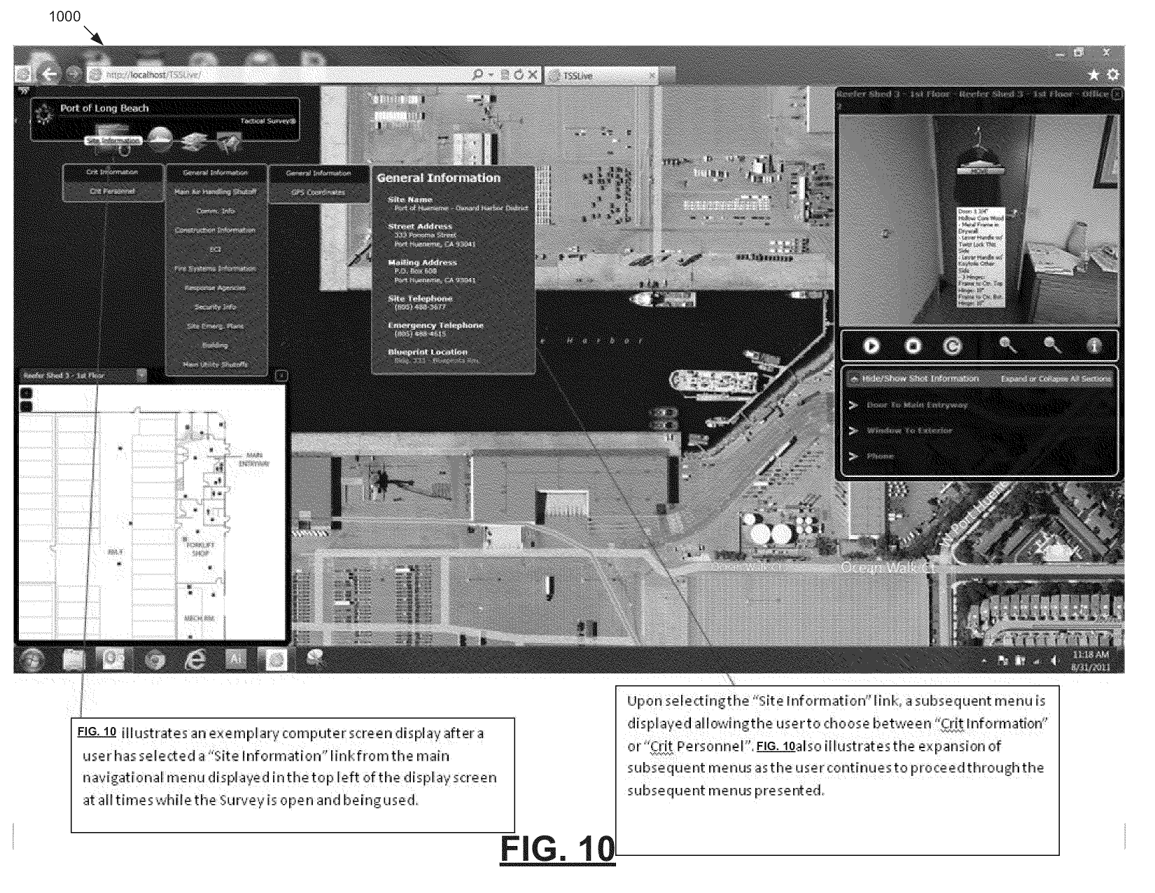

FIG. 10 is a graphical user interface depicting an accessing of information via menus. A user may traverse a critical information menu, which may be always available, and drill down through subsequent menus to identify general information about a site, such as the site name, address, phone numbers, and blueprints location.

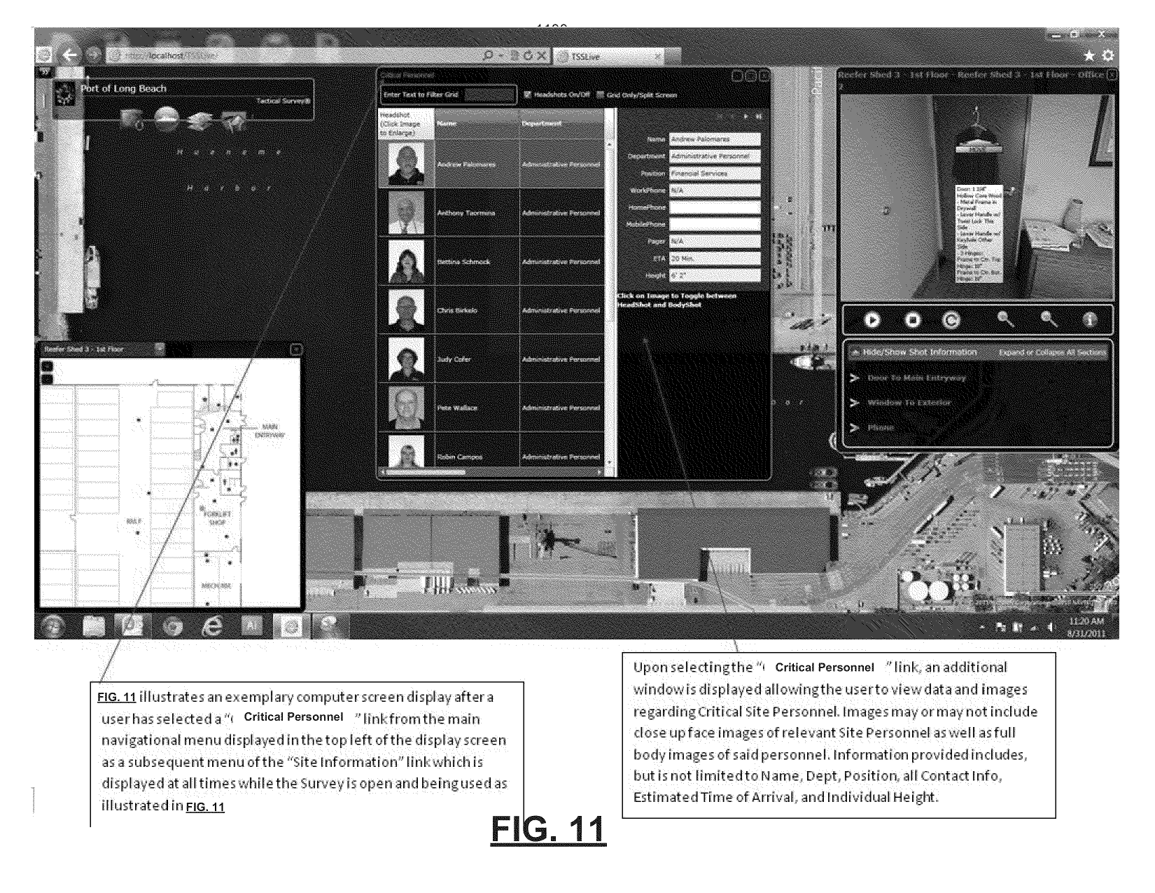

FIG. 11 is a graphical user interface displaying key personnel data. The key personnel data may be displayed upon user selection of a critical personnel sub-link of a site information menu. Upon selection of the critical personnel link, an additional window is displayed allowing the user to view data and images regarding critical site personnel. Images may be provided including headshots and full-body images. Personnel data provided may include name, department, position, contact information, time of arrival, and height.

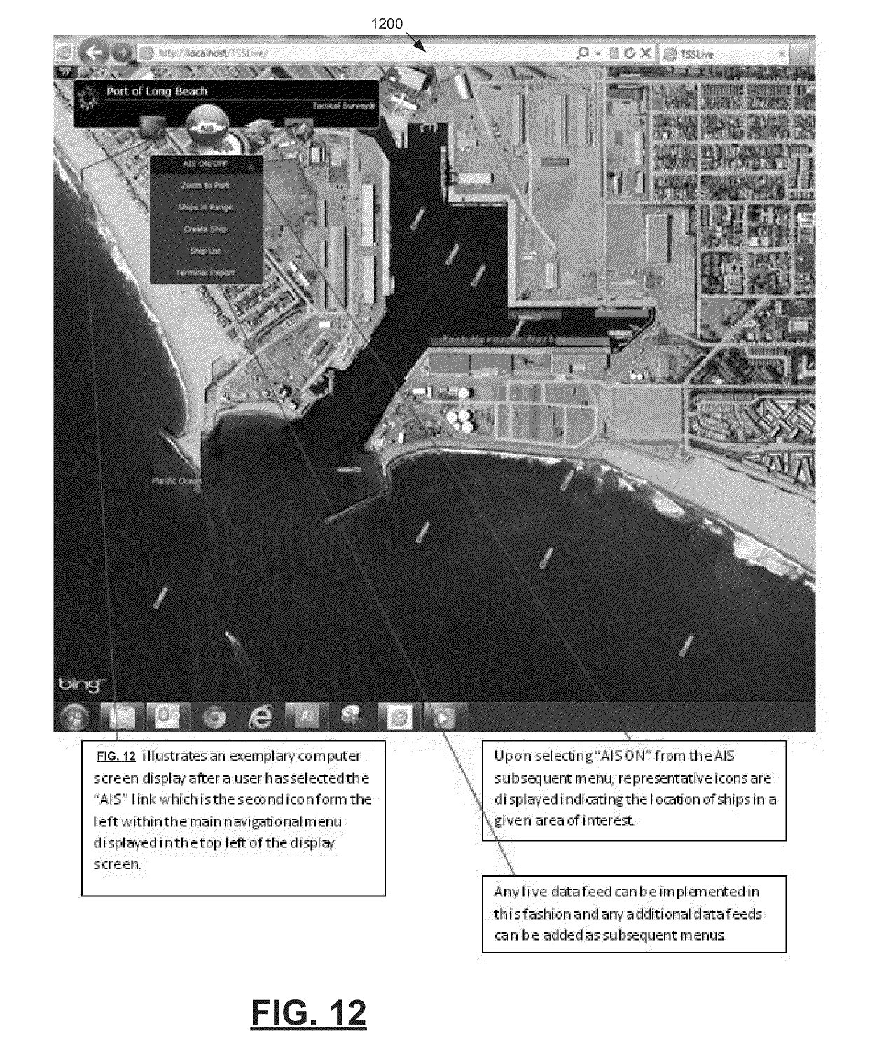

FIG. 12 is a graphical user interface depicting overlaying of real-time mobile entity data. Mobile entity data overlay may be toggled via selection of an AIS link. Upon selection of the AIS ON control, representative icons are displayed indicating locations of mobile entities (e.g., ships) in a site, structure, or other display. In a ship mobile entity display implementation, the mobile entity data may include data from any AIS/VTS tracking system feed and display it on a live world map. The mobile entity overlay may visually represent the ship's heading and size. If a ship for does not appear in the data feed, then the tactical data display engine may allow the ability to create a user defined ship and position it manually. The engine may allow users to schedule the offloading/loading of ship cargo, select the berth where it will be docked, select the terminal where the cargo will be housed, track the status of the transaction (Scheduled, In Process, Complete, Scheduled to Depart), and view a report of ships within two (2) miles of the port.

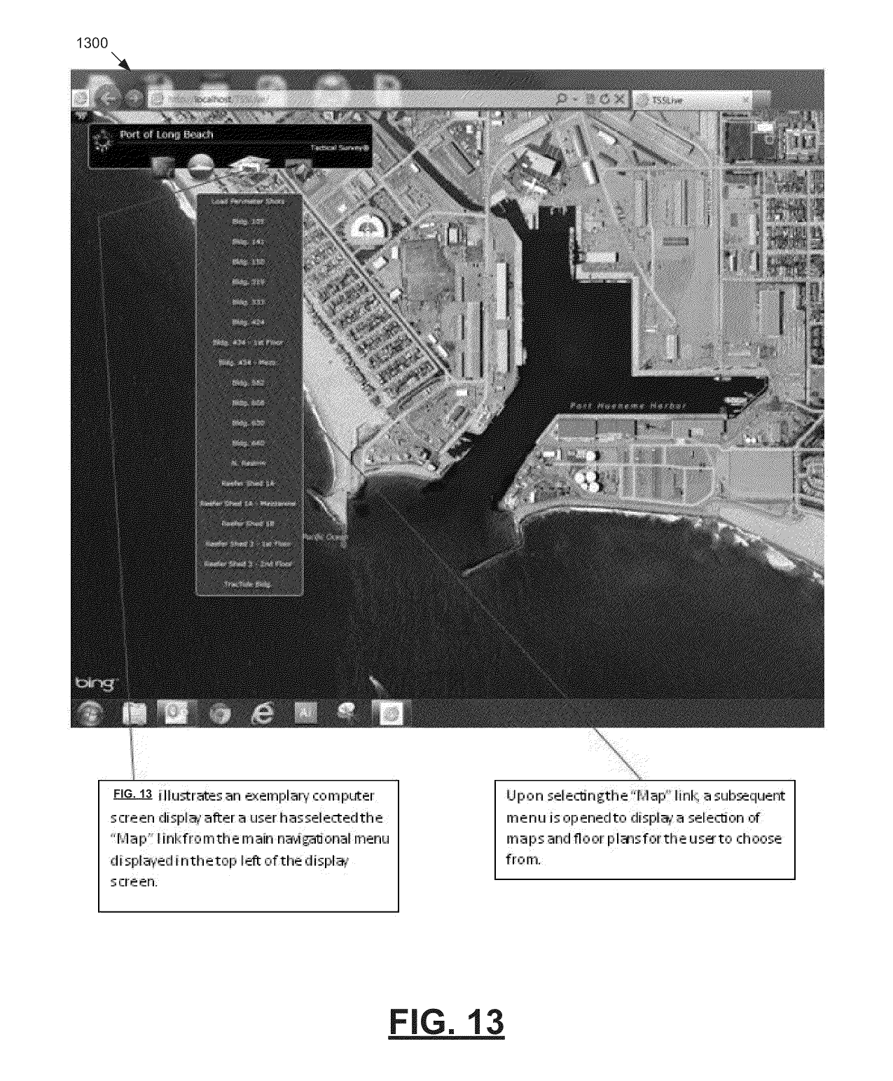

FIG. 13 is a graphical user interface displaying a menu for selecting maps and floor plans via a text list. Upon selection of a map menu link, a subsequent menu is opened to display a selection of maps and floor plans for selection. Upon selection, an indicated map or floor plan is accessed and displayed to the user.

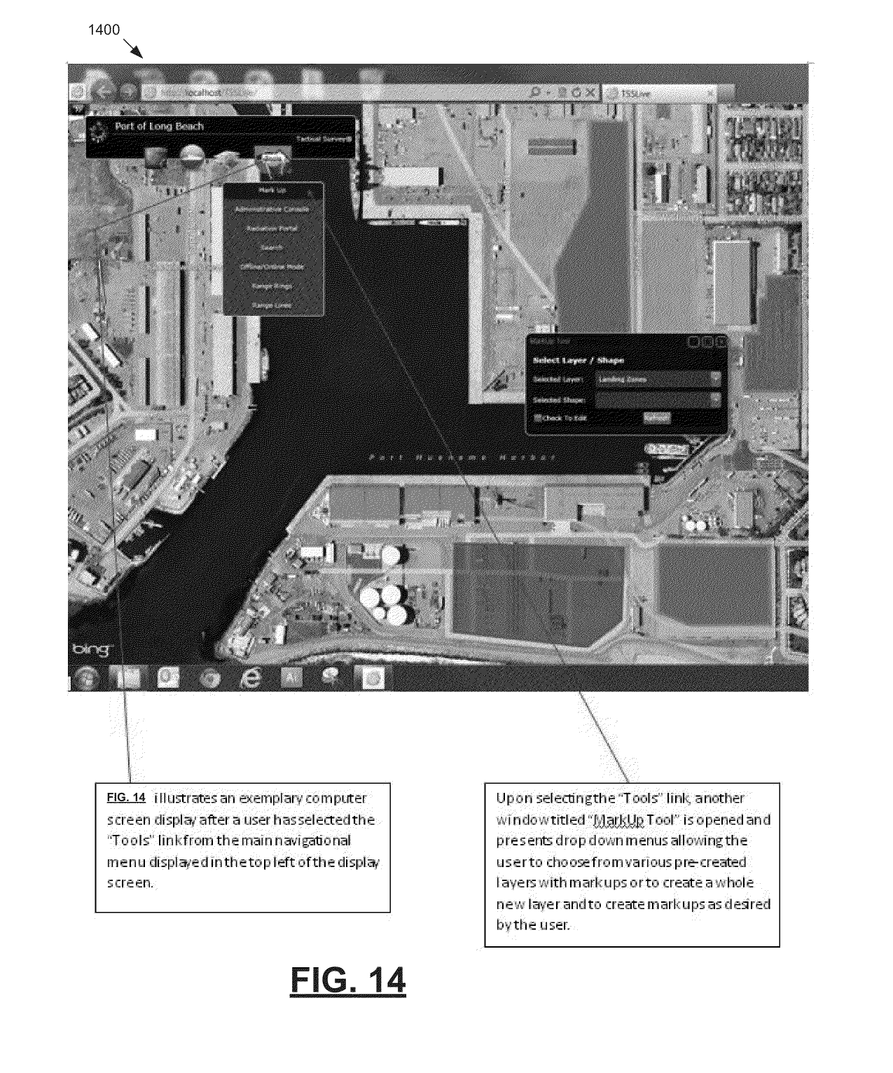

FIG. 14 is a graphical user interface that includes display markup tools. Upon selection of a tools menu link, a markup tool window is opened. The markup tool window provides a variety of pre-created layers with markups or tools for generating a new layer and/or markups. The tools provide the ability to create/edit/delete a user defined layer/group of custom map shapes/overlays. Custom shapes can then be viewed as a group on a world map base layer. Each shape can be drawn using a world map as the base layer. The following properties can be customized for each shape: Display Name, Line Width, Line Color (using a dynamic color tool), Line Opacity, Fill Color (using a dynamic color tool), and Fill Opacity. Upon saving of display markups, the markups may be saved in the tactical store data stores for view by the user and/or other users.

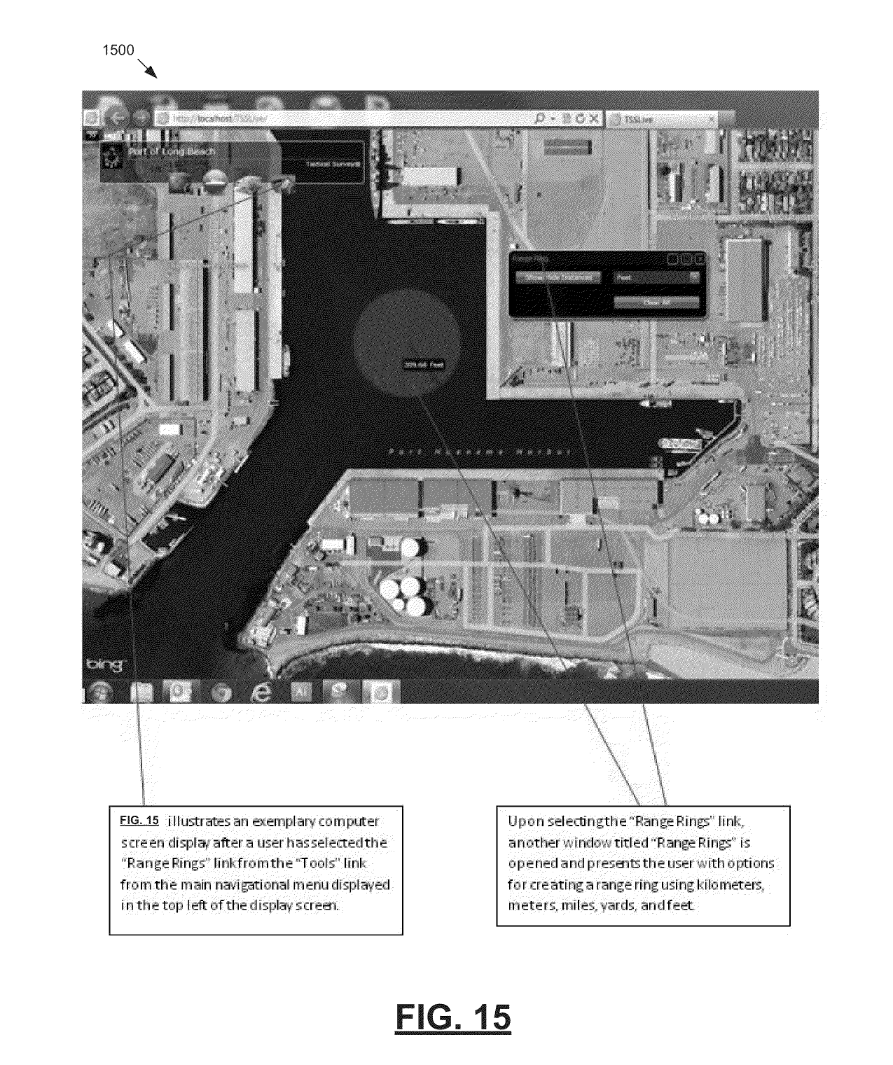

FIG. 15 is a graphical user interface depicting a range ring generation. Upon selection of a range rings option from a tools menu link, a range rings window is opened with tools for generation of a range ring, such as units selection. A range ring is displayed on the site map display or the floor plan display based on a received range ring command. The range ring command selects a center of the range ring and an edge point of the range ring. The range ring is displayed as a circle centered at the selected center with an edge at the selected edge point, where the range ring identifies a length of a radius of the circle. A range ring may be moved by a user (e.g., via a mouse-drag operation) for repositioning anywhere on a map.

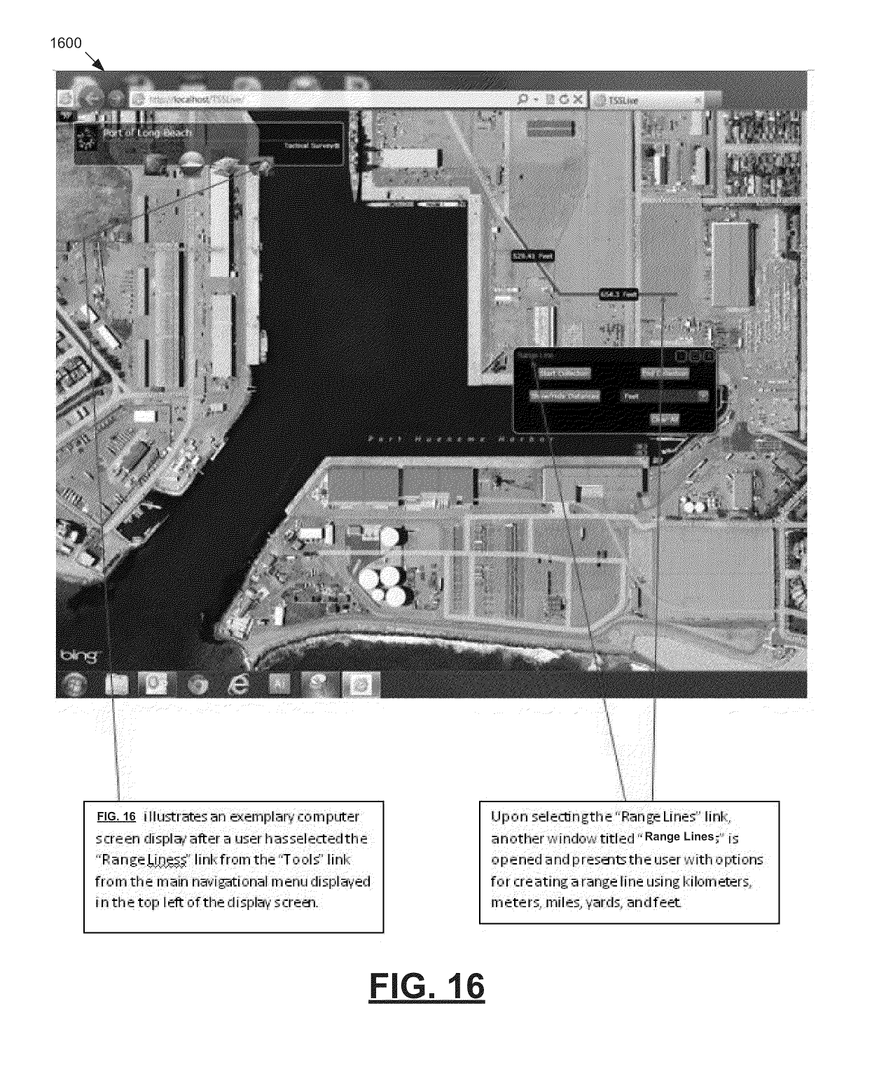

FIG. 16 is a graphical user interface depicting a set of range lines. A range lines link may be selected as a sub-option of a tools link. Upon selecting the range lines link, a range lines display is opened and presents the user with options for creating range lines and selecting units for the range lines. A set of range lines are displayed on the site map display or the floor plan display based on a received range lines command. A range lines command identifies a starting point and one or more segment ending points, where the set of range lines are a set of line segments beginning at the identified starting point and sequentially advancing through the one or more identified segment ending points. The set of range lines identifies a cumulative distance along the set of line segments.

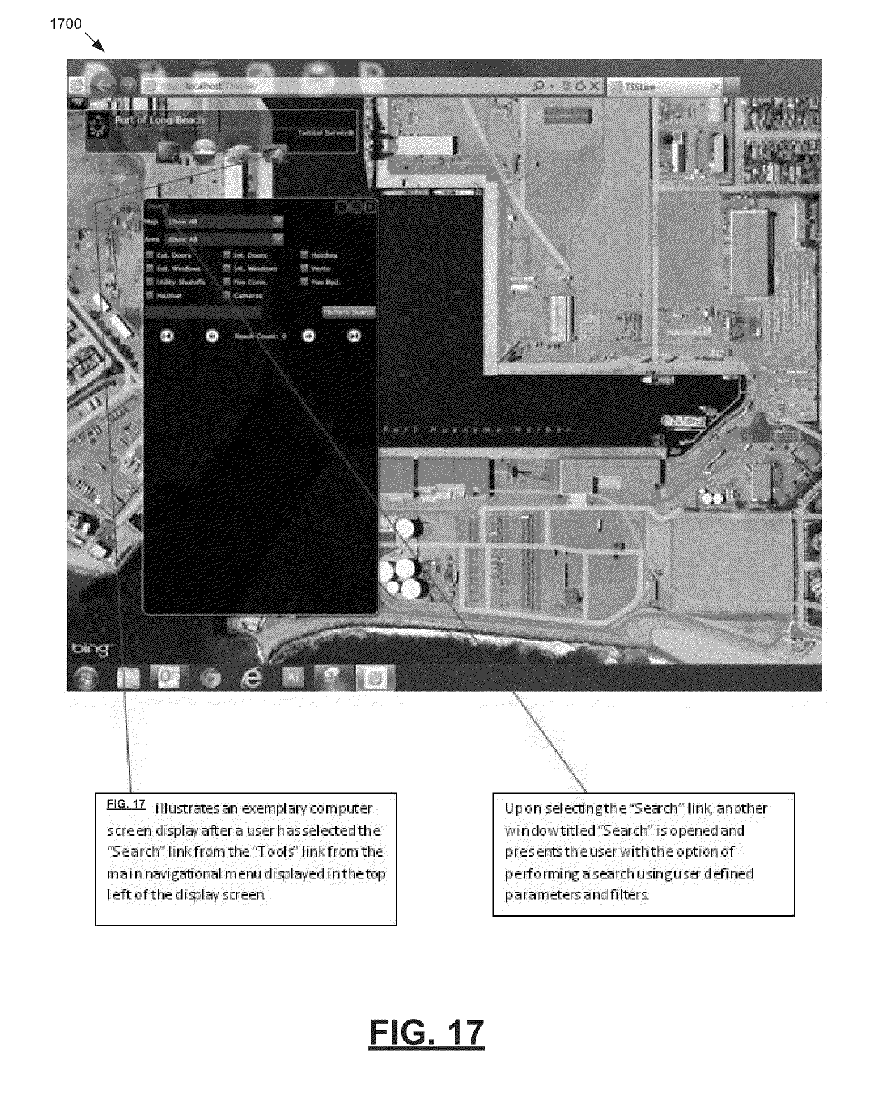

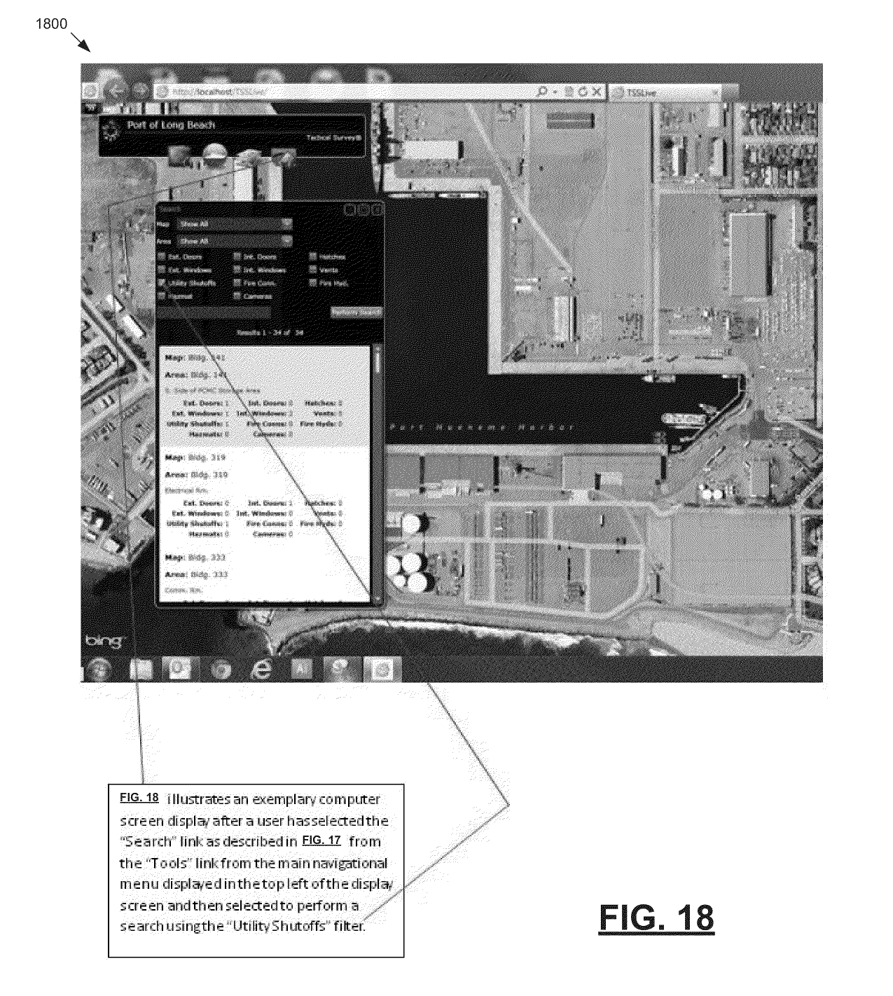

FIG. 17 is a graphical user interface displaying a search tool accessed from a tools menu. A search window is opened that presents the user with options for performing a search. A search command offers the ability to filter by map and area. In addition to filtering by map and area, checkboxes are provided that fill further refine a search to look for specific types of survey objects, such as: Exterior Doors, Interior Doors, Hatches, Exterior Windows, Interior Windows, Vents, Utility Shutoffs, Fire Connections, Fire Hydrants, Hazmat, and Cameras. A text box that accepts additional free form text may also provided to look for specific words. Search results may be displayed with the following properties for each result and listed by shot location: Map, Area, a count of the number of each type of main survey object, Exterior Doors, Interior Doors, Hatches, Exterior Windows, Interior Windows, Vents, Utility Shutoffs, Fire Connections, Fire Hydrants, Hazmat, and Cameras. Each result item may be clickable and when clicked will load the appropriate floor plan map and panoramic image, rotated and zoomed to the selected item.

FIG. 18 is a graphical user interface depicting search results. The depicted search results were located by performing a search for utility shutoffs. The results pane identifies all utility shutoffs for the site. Clicking a result may access additional details and photos of the selected result.

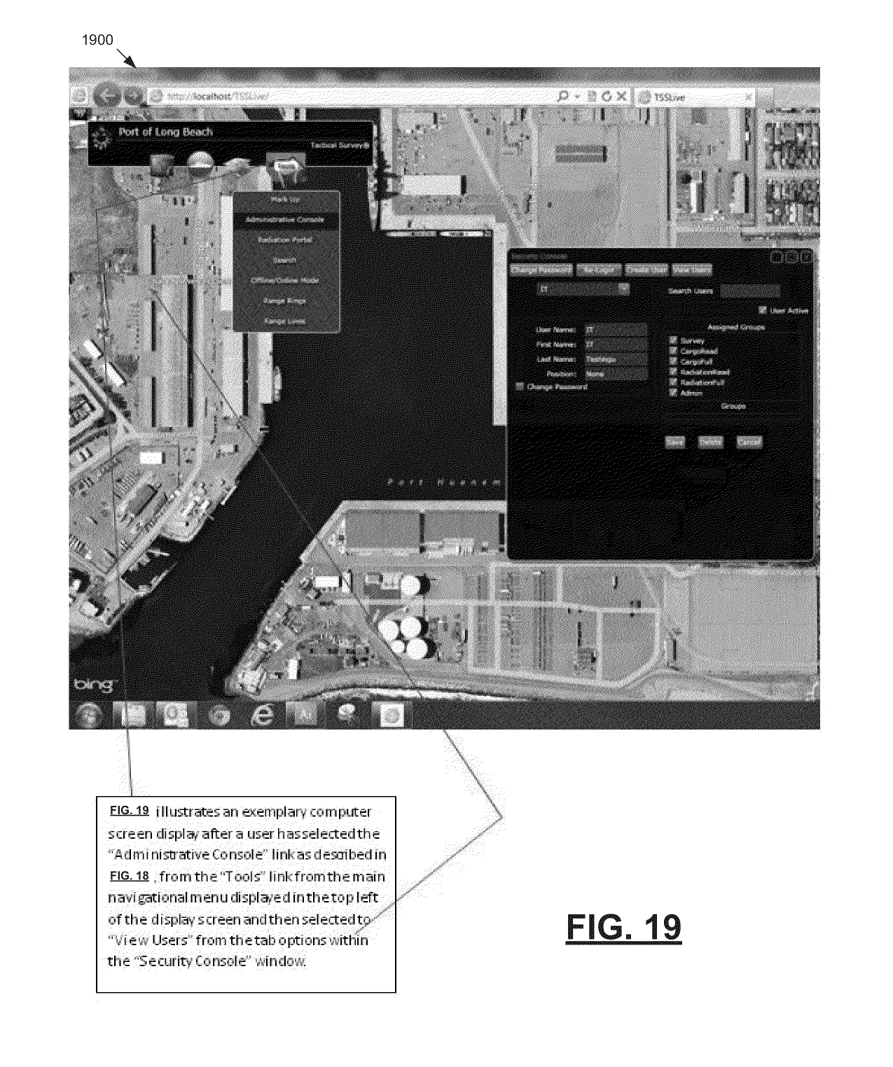

FIG. 19 is a graphical user interface depicting administrative options. An administrative options menu may be accessed via a link from a tools menu. The depicted administrative options menu shows controls accessed by selecting a view users tab. In the administrative options menu, an administrator can create users and assign them to groups. An administrator may also implement and manage group membership controls, which control what level of access a user has to specific modules as well as a level of read or read/write access to these modules.

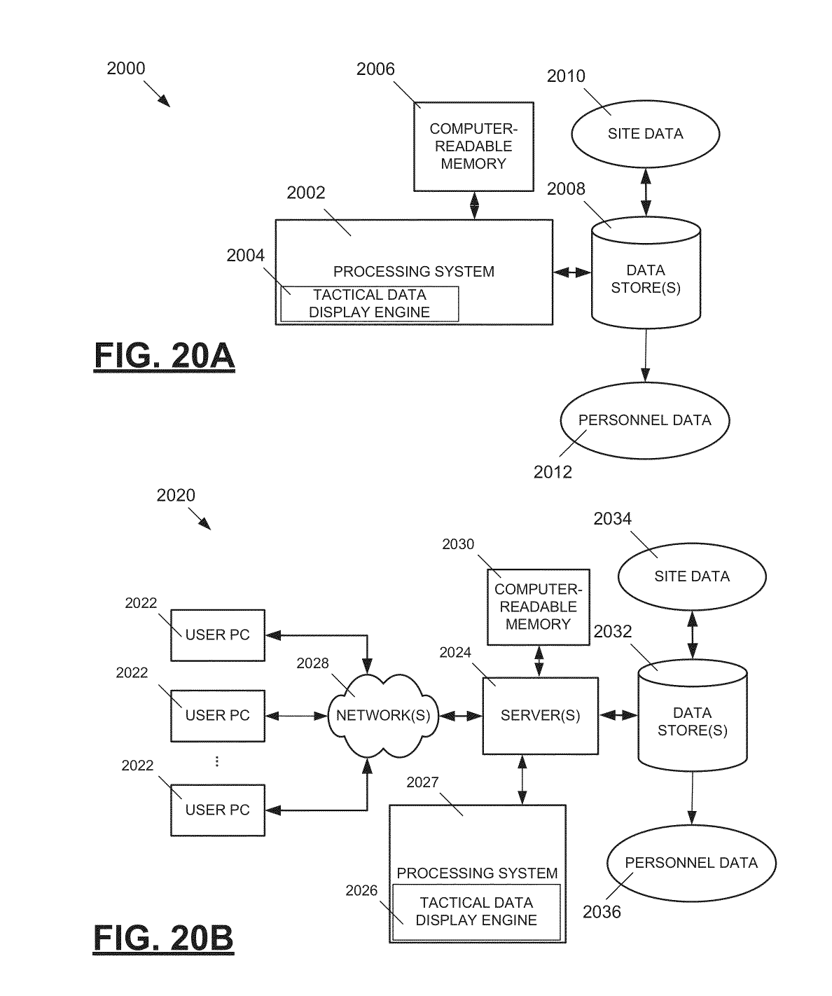

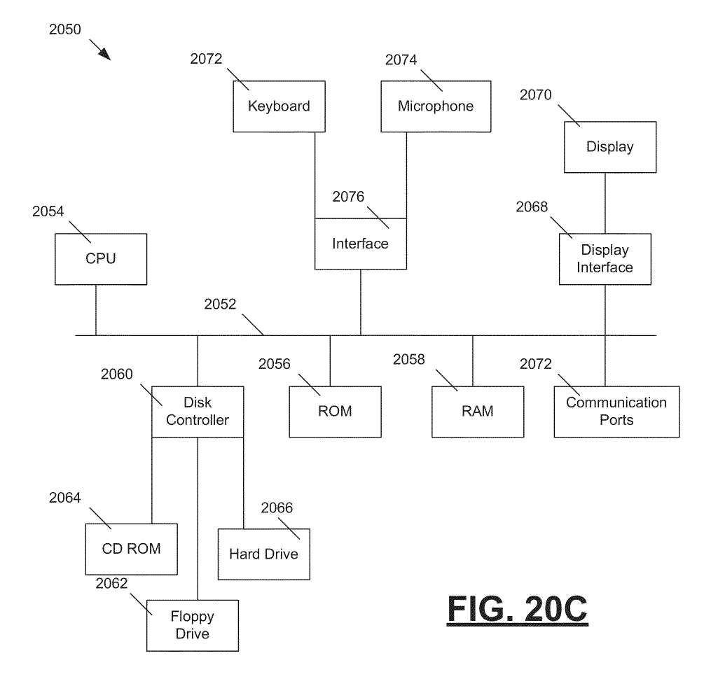

FIGS. 20A, 20B, and 20C depict example systems for use in implementing a tactical data display engine. For example, FIG. 20A depicts a system 2000 that includes a standalone computer architecture where a processing system 2002 (e.g., one or more computer processors) includes a tactical data display engine 2004 being executed on it. The processing system 2002 has access to a computer-readable memory 2006 in addition to one or more data stores 2008. The one or more data stores 2008 may include site data 2010 as well as personnel data 2012.

FIG. 20B depicts a system 2020 that includes a client server architecture. One or more user PCs 2022 accesses one or more servers 2024 running a tactical data display engine 2026 on a processing system 2027 via one or more networks 2028. The one or more servers 2024 may access a computer readable memory 2030 as well as one or more data stores 2032. The one or more data stores 2032 may contain site data 2034 as well as personnel data 2036.

FIG. 20C shows a block diagram of example hardware for a standalone computer architecture 2050, such as the architecture depicted in FIG. 20A that may be used to contain and/or implement the program instructions of system embodiments of the present invention. A bus 2052 may serve as the information highway interconnecting the other illustrated components of the hardware. A processing system 2054 labeled CPU (central processing unit) (e.g., one or more computer processors), may perform calculations and logic operations required to execute a program. A processor-readable storage medium, such as read only memory (ROM) 2056 and random access memory (RAM) 2058, may be in communication with the processing system 2054 and may contain one or more programming instructions for performing the method of implementing a tactical data display engine. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 2060 interfaces one or more optional disk drives to the system bus 2052. These disk drives may be external or internal floppy disk drives such as 2062, external or internal CD-ROM, CD-R, CD-RW or DVD drives such as 2064, or external or internal hard drives 2066. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 2060, the ROM 2056 and/or the RAM 2058. Preferably, the processor 2054 may access each component as required.

A display interface 2068 may permit information from the bus 2052 to be displayed on a display 2070 in audio, graphic, or alphanumeric format. Communication with external devices may optionally occur using various communication ports 2072.

In addition to the standard computer-type components, the hardware may also include data input devices, such as a keyboard 2073, or other input device 2074, such as a microphone, remote control, pointer, mouse and/or joystick.

As additional examples, for example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented system for providing tactical information to a crisis responder, comprising:
one or more data processors;
one or more computer-readable mediums containing instructions for commanding the one or more data processors to execute instructions for providing a tactical information user interface to the crisis responder, wherein the user interface includes:
a site map display that provides a depiction of features at a site of interest, wherein the site of interest includes one or more structures, wherein semi-opaque polygons are overlaid over structures for which drill down data is available;
a floor plan display that provides a floor plan of a structure of interest, wherein the floor plan includes one or more identified areas for which drill down data is available, wherein one of the one or more structures is identified as the structure of interest upon selection of an associated semi-opaque polygon in the site map display, wherein the site map display is zoomed and centered based on the structure of interest upon identification of the structure of interest, and wherein a feature of the semi-opaque polygon associated with the structure of interest is changed upon identification of the structure of interest;
a panoramic photo display that provides a zoomable, rotatable photo of an area of interest, wherein one of the one or more identified areas is identified as the area of interest upon selection of that area in the floor plan display; and
a real-time data display that provides real time data associated with the site of interest, wherein the real-time data display provides real-time picture, video, or sensor data in conjunction with one or more of the site map display, the floor plan display, and the panoramic photo display.

2. The system of claim 1, wherein the floor plan display includes a panoramic photo direction of view indicator, wherein the direction of view indicator identifies a direction on the floor plan map that corresponds with a portion of the photo being displayed in the panoramic photo display.

3. The system of claim 1, wherein the photo includes depictions of one or more items for which drill down data is available, wherein points in the photo associated with a particular item are associated with the drill down data for the particular item.

4. The system of claim 3, wherein upon selection of the points in the photo, the drill down data for the particular item is displayed in a drill down data display.

5. The system of claim 3, wherein the drill down data for the particular item is displayed on the panoramic photo near the points in the photo associated with the particular item.

6. The system of claim 3, wherein upon selection of an item in a non-panoramic photo display, a panoramic photo that includes the selected item is displayed and rotated to show the selected item.

7. The system of claim 1, wherein the site map includes a live data overlay, wherein the live data overlay depicts locations of mobile entities on the site map, wherein the locations of the mobile entities are received wirelessly.

8. The system of claim 1, wherein the mobile entities are boats, cars, vehicles, or personnel.

9. The system of claim 1, wherein a range ring is displayed on the site map display or the floor plan display based on a received range ring command, wherein the range ring command selects a center of the range ring and an edge point of the range ring, wherein the range ring is a circle centered at the selected center with an edge at the selected edge point, wherein the range ring identifies a length of a radius of the circle.

10. The system of claim 1, wherein a set of range lines are displayed on the site map display or the floor plan display based on a received range lines command, wherein the range lines command identifies a starting point and one or more segment ending points, wherein the set of range lines are a set of line segments beginning at the identified starting point and sequentially advancing through the one or more identified segment ending points, wherein the set of range lines identifies a cumulative distance along the set of line segments.

11. The system of claim 1, wherein data for the site map display, the floor plan display, or the panoramic photo display is received wirelessly in real time.

12. A computer-implemented method for providing tactical information to a crisis responder, comprising:
displaying, using one or more data processors, a site map display that provides a depiction of features at a site of interest, wherein the site of interest includes one or more structures, wherein semi-opaque polygons are overlaid over structures for which drill down data is available;
displaying, using the one or more data processors, a floor plan display that provides a floor plan of a structure of interest, wherein the floor plan includes one or more identified areas for which drill down data is available, wherein one of the one or more structures is identified as the structure of interest upon selection of an associated semi-opaque polygon in the site map display, wherein the site map display is zoomed and centered based on the structure of interest upon identification of the structure of interest, and wherein a feature of the semi-opaque polygon associated with the structure of interest is changed upon identification of the structure of interest;
displaying, using the one or more data processors, a panoramic photo display that provides a zoomable, rotatable photo of an area of interest, wherein one of the one or more identified areas is identified as the area of interest upon selection of that area in the floor plan display; and
displaying, using the one or more data processors, a real-time data display that provides real time data associated with the site of interest, wherein the real-time data display provides real-time picture, video, or sensor data in conjunction with one or more of the site map display, the floor plan display, and the panoramic photo display.

13. The method of claim 12, wherein the floor plan display includes a panoramic photo direction of view indicator, wherein the direction of view indicator identifies a direction on the floor plan map that corresponds with a portion of the photo being displayed in the panoramic photo display.

14. The method of claim 12, wherein the photo includes depictions of one or more items for which drill down data is available, wherein points in the photo associated with a particular item are associated with the drill down data for the particular item.

15. The method of claim 14, wherein upon selection of the points in the photo, the drill down data for the particular item is displayed in a drill down data display.

16. The method of claim 14, wherein the drill down data for the particular item is displayed on the panoramic photo near the points in the photo associated with the particular item.

17. The method of claim 14, wherein upon selection of an item in a non-panoramic photo display, a panoramic photo that includes the selected item is displayed and rotated to show the selected item.

18. The method of claim 12, wherein the site map includes a live data overlay, wherein the live data overlay depicts locations of mobile entities on the site map, wherein the locations of the mobile entities are received wirelessly.

19. The method of claim 12, wherein the mobile entities are boats, cars, vehicles, or personnel.

20. The method of claim 12, wherein a range ring is displayed on the site map display or the floor plan display based on a received range ring command, wherein the range ring command selects a center of the range ring and an edge point of the range ring, wherein the range ring is a circle centered at the selected center with an edge at the selected edge point, wherein the range ring identifies a length of a radius of the circle.
